(19) United States
(12) Patent Application Publication
(10) Pub. No.: US 2026/0289380 A1
(43) Pub. Date: Sep. 24, 2026

(54) QUBIT ARRAY, QUANTUM COMPUTER, AND QUANTUM ERROR DETECTION METHOD

(71) Applicant: Hitachi, Ltd., Tokyo (JP)

(72) Inventors: Tatsuya TOMARU, Tokyo (JP); Satoru AKIYAMA, Tokyo (JP); Takashi TAKEMOTO, Tokyo (JP)

(21) Appl. No.: 19/456,833

(22) Filed: Jan. 22, 2026

(30) Foreign Application Priority Data
Feb. 27, 2025 (JP) 2025-030468

(51) Int. Cl. G06N 10/70; G06N 10/40

(52) U.S. Cl. CPC G06N 10/70; G06N 10/40

(57) ABSTRACT

There is provided a qubit array that realizes computations between a plurality of logical qubits implementing a quantum error correction code while securing space for the wiring and elements required for qubit control. The qubit array includes: a first quantum dot row in which a plurality of data qubits or a plurality of syndrome qubits are arranged so as to be movable; and a second quantum dot row in which the plurality of data qubits or the plurality of syndrome qubits are fixed. A double ring including an outer ring and an inner ring is formed by arranging a pair of the first quantum dot row and the second quantum dot row in a loop shape.

### CROSS-REFERENCE TO RELATED APPLICATION

The present application claims priority from Japanese application JP2025-030468, filed on Feb. 27, 2025, the content of which is hereby incorporated by reference into this application.

### BACKGROUND OF THE INVENTION

### 1. Field of the Invention The present invention relates to a qubit array, a quantum computer, and a quantum error detection method.

### 2. Description of the Related Art

The ultimate goal of quantum computer development is a fault-tolerant quantum computer (FTQC), and various research and development efforts are being actively carried out to achieve this. There are many candidates for the type of physical system to be used for the qubits, which are the basic elements of a quantum computer, and each is being actively studied. From the viewpoint of integration, methods that use silicon electron spins are advantageous.

Silicon has a very high integration capacity, which is advantageous for large-scale implementation. However, since the integration capacity is too high, there is a challenge in that sufficient space for control lines and the like cannot be secured. Therefore, reducing the integration to secure space for control lines and the like becomes a practical solution.

In a quantum computer that implements quantum error correcting codes, qubits are classified into data qubits and syndrome qubits, and redundant information is stored in the former data qubits. The latter syndrome qubits are used for measurement to detect errors, and are measured after transferring information from a plurality of data qubits. By analyzing the measurement results, it is possible to deduce which qubit had what kind of errors.

As a means for securing the above-described space for control lines and the like, it is known to align the data qubits and the syndrome qubits in parallel in a one-dimensional manner to form a 2×N array (see Adam Siegel et al., arXiv:2402.12599).

The data qubits are moved in a one-dimensional direction to change the combinations of adjacent data qubits and syndrome qubits, thereby transferring information regarding a plurality of data qubits. Since qubits are limited to 2×N columns, sufficient space for control lines and the like can be secured.

However, if data qubits are aligned in a one-dimensional manner, logical qubits formed by that group are also arranged in a one-dimensional manner. In order to perform a computation between two logical qubits that are not adjacent, for example, it is necessary to move (shuttle), over a long distance, syndrome qubits that mediate interaction between the two target logical qubits, or to swap the target logical qubits so as to become adjacent to each other, or to merge logical qubits located between the target logical qubits with one of the target logical qubits so that the target logical qubits become adjacent to each other.

This is a significant limitation. If the two logical qubits that are to interact are separated by about the size of the array, the number of computations that can be performed at one time is O(1) (on the order of 1) regardless of the number of logical qubits, and a single gate operation uses almost the entire qubit array. In other words, parallel computations are generally not possible.

From a slightly different perspective, an idea is disclosed in which each qubit is not fixed at one point, but is moved to perform necessary operations (see Zhenyu Cai et al., Phys. Rev. X4, 020345 (2023)). Thanks to this manner, the used space is expanded. This idea intends to expand the space in units of a qubit, but extensions have also been proposed in which a plurality of qubits are grouped to expand the space (see Adam Siegel et al., arXiv:2501.02120). Here, an idea is also presented in which a plurality of grouped qubits move space to space.

However, the disclosure in Adam Siegel et al., arXiv:2501.02120 is merely an idea, and does not provide any disclosure regarding implementation in a device. Taking the expanded functionality into consideration, it is expected that the device structure or operation will become complex.

### SUMMARY OF THE INVENTION

When we take the above background technology into consideration, the issues are to secure space for control lines and the like, to eliminate the situation in which parallel computations cannot be performed as described above, and to achieve these two things by means of a simple and easy approach that is implementable on a device.

In particular, in Adam Siegel et al., arXiv:2402.12599, Zhenyu Cai et al., Phys. Rev. X4, 020345 (2023), and Adam Siegel et al., arXiv:2501.02120, error correction is implemented in a one-dimensional array, but there are constraints on computations between logical qubits arising from the one-dimensional nature or a problem that the shuttling distance increases.

It is an object of the present invention to provide a qubit array that realizes computations between a plurality of logical qubits implementing quantum error correction while securing space for the wiring and elements required for qubit control.

A qubit array according to one aspect of the present invention includes: a first quantum dot row in which a plurality of data qubits or a plurality of syndrome qubits are arranged so as to be movable; and a second quantum dot row in which the plurality of data qubits or the plurality of syndrome qubits are fixed. A double ring including an outer ring and an inner ring is formed by arranging a pair of the first quantum dot row and the second quantum dot row in a loop shape. By using a plurality of gate electrodes, the plurality of data qubits or the plurality of syndrome qubits are moved along the first quantum dot row to change positional relationships between the first quantum dot row and the second quantum dot row, i.e., the relationships between the plurality of data qubits and the plurality of syndrome qubits. By using the plurality of gate electrodes, two-qubit computations are executed between the plurality of data qubits and the plurality of syndrome qubits while changing the positional relationships.

According to one aspect of the present invention, it is possible to provide a qubit array that realizes computations between a plurality of logical qubits implementing quantum error correction while securing space for the wiring and elements required for qubit control.

### BRIEF DESCRIPTION OF THE DRAWINGS

FIG. 1 is a diagram showing the configuration of a logical qubit with a code distance of 3;

FIG. 2A is a diagram showing a quantum circuit for syndrome measurement (stabilizer measurement) responsible for bit-flip error detection, and FIG. 2B is a diagram showing a quantum circuit for syndrome measurement (stabilizer measurement) responsible for phase-flip error detection;

FIG. 3 is a diagram showing an implementation example of a qubit array including a plurality of logical qubits;

FIG. 4 is a diagram showing a qubit array showing a scene of the operation of logical qubits;

FIG. 5 is a diagram showing a qubit array showing another example of a scene of the operation of logical qubits;

FIG. 6A is a diagram showing two-dimensionally arranged logical qubits, and FIG. 6B is a diagram showing logical qubits obtained by converting the logical qubits shown in FIG. 6A so as to be arranged in a one-dimensional manner;

FIG. 7A is a diagram showing a two-dimensional arrangement of two logical qubits merged, and FIG. 7B is a diagram obtained by converting FIG. 7A into a one-dimensional arrangement;

FIGS. 8A and 8B are diagrams in which the numbering in FIGS. 7A and 7B are changed;

FIG. 9A is a diagram showing a two-dimensional array of four logical qubits, and FIG. 9B is a diagram showing a converted array that is in a one-dimensional manner but in a square shape (ring shape);

FIG. 10A is a diagram showing a two-dimensional array of eight logical qubits, and FIG. 10B is a diagram showing an arrangement in which four logical qubits are arranged in a square shape (ring shape) and the two rings are coupled with each other;

FIG. 11A is a diagram showing a two-dimensional array of a large number of logical qubits, and FIG. 11B is a diagram showing an arrangement in which 12 logical qubits are arranged in a ring shape (loop shape) and those rings are coupled with one another;

FIG. 12A is an enlarged view of block B in FIG. 11A, and FIG. 12B is a diagram obtained by converting FIG. 12A into a one-dimensional array;

FIG. 13A is an enlarged view of block C in FIG. 11A, and FIG. 13B is a diagram obtained by converting FIG. 13A into a one-dimensional array;

FIG. 14A is an enlarged view of block B in FIG. 11A, and FIG. 14B is a diagram obtained by adding quantum dots for measurement to FIG. 12B;

FIG. 15A is an enlarged view of block B in FIG. 11A, and FIG. 15B is a diagram in which the syndrome qubits in FIG. 14B have been moved by one dot;

FIG. 16A is an enlarged view of block C in FIG. 11A, and FIG. 16B is a diagram obtained by adding quantum dots for measurement to FIG. 13B;

FIG. 17A is an enlarged view of block C in FIG. 11A, and FIG. 17B is a diagram in which the syndrome qubits in FIG. 16B have been moved by one dot;

FIG. 18A is an enlarged view of block B in FIG. 11A, FIG. 18B is a diagram obtained by adding electrodes to FIG. 14B, and

FIG. 18C is a cross-sectional view of a substrate and a gate electrode portion;

FIG. 19A is an enlarged view of block C in FIG. 11A, FIG. 19B is a diagram obtained by adding electrodes to FIG. 16B, and FIG. 19C is a cross-sectional view of a substrate and a gate electrode portion; and

FIG. 20 is an overall view of a system including a quantum computing device.

### DETAILED DESCRIPTION OF THE PREFERRED EMBODIMENTS

A fault-tolerant quantum computer (FTQC) is a quantum computer in which a quantum error correcting code is implemented. As a representative code, a surface code is known. In the following embodiments, the surface code will be described as an example. As will be apparent from the following description, the present invention is not limited to the surface code and can be applied to any code.

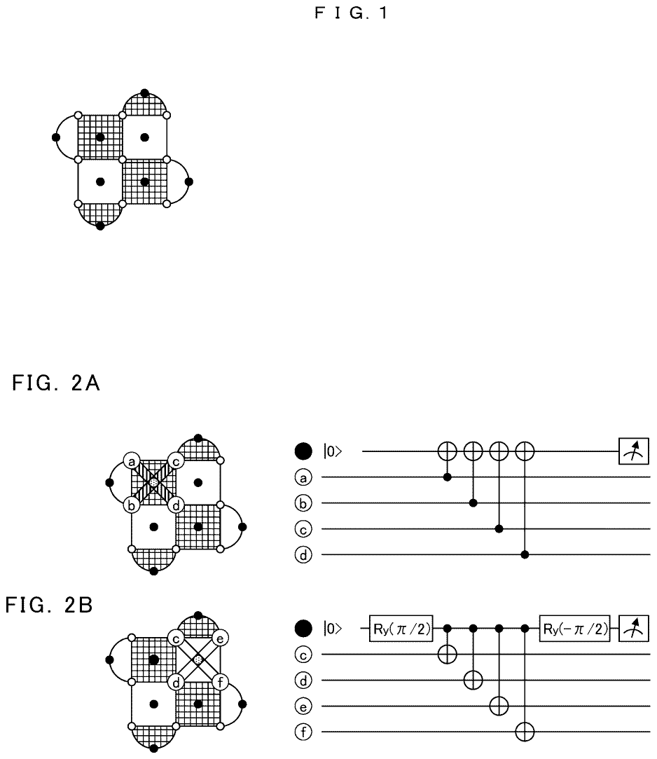

Before describing the embodiments in detail, the surface code will be described. FIG. 1 shows an example of the implementation of the surface code when the code distance is 3.

Qubits are classified into data qubits and syndrome qubits, with the former placed at the vertices of a two-dimensional lattice (∘) and the latter placed at the centers of surfaces (●). The number of data qubits is 9, and the number of syndrome qubits is 8. Information is stored in the data qubits, and the syndrome qubits are measurement qubits for error detection. Each syndrome qubit is measured after information is transferred from the 2- to 4-nearest data qubits. 9−8=1 is the amount of information in a logical qubit.

FIGS. 2A and 2B are circuit diagrams related to information transfer and measurement. The syndrome qubits are classified into those responsible for detecting bit-flip errors and those responsible for detecting phase-flip errors, and the corresponding circuits are shown in FIGS. 2A and 2B. A sequence of operations based on FIGS. 2A and 2B is called syndrome measurement (stabilizer measurement).

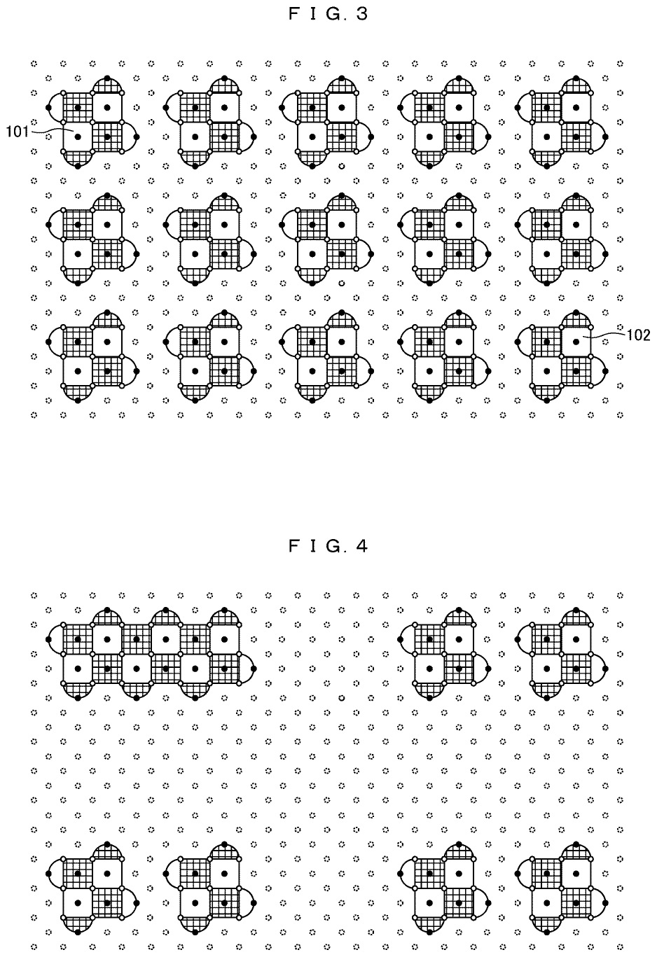

One logical qubit is formed by the entirety of FIG. 1. A plurality of logical qubits are realized by aligning a plurality of these things as shown in FIG. 3. Computations for each logical qubit are performed on respective logical qubits. Computations between two logical qubits are realized through merging and splitting the two target logical qubits. The upper left of FIG. 4 shows a merged state. Computations between logical qubits that are not adjacent is realized by securing a region where no logical qubits are arranged and moving (shuttling) the entire logical qubit as shown in FIG. 4 or by swapping (SWAP) each qubit (referred to as a physical qubit) that forms the logical qubit so that the logical qubits to be interacted are brought adjacent to each other. When qubits are constructed with semiconductor electron spins, quantum dots are formed at the positions where each qubit is to be placed, thereby the position of each qubit is seated.

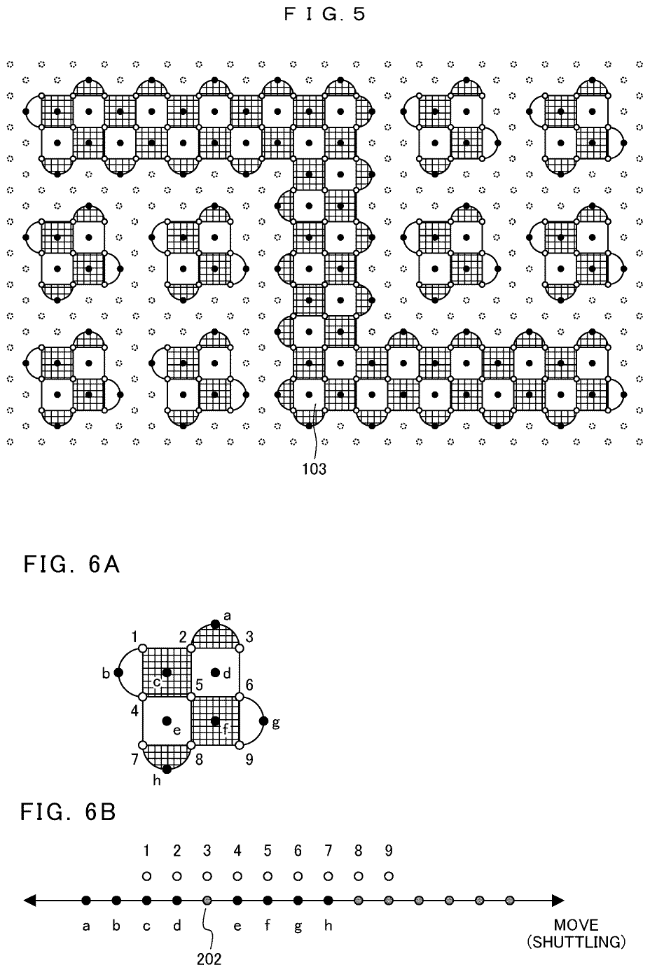

In FIG. 4, when shuttling is used, the quantum dots in regions where logical qubits are not arranged are left vacant as a general rule. The reason for the “general” herein is that, as shown in FIG. 4 or 5, when logical qubits are merged, the positions of quantum dots that were originally vacant become a part of the logical qubit, and qubits are required at that portion in merging. When using swapping, electrons (qubits) are, as a general rule, arranged even in the quantum dots of regions where logical qubits are not arranged. The reason for the “general” herein is that vacant quantum dots are necessary when shuttling is used in combination.

Computations between logical qubits that are not adjacent to each other can also be realized by merging a plurality of logical qubits interposed between the two target logical qubits. For example, 103 in FIG. 5 represents a state in which a plurality of logical qubits interposed between 101 and 102 in FIG. 3 are merged as well. Also, when the form of 103 in FIG. 5 being taken, electrons (qubits) are, as a general rule, arranged in the quantum dots in regions where no logical qubits are placed. The reason for the “general” herein is that when shuttling is used in combination, vacant quantum dots are also necessary.

### First Embodiment

As shown in FIG. 2, the surface code performs information transfer by performing a CNOT operation between nearest-neighbor data qubits and syndrome qubits. Since only nearest-neighbor interactions are used, the positional relationship between the data qubits and the syndrome qubits can be fixed if the qubits are arranged in a two-dimensional manner as shown in FIGS. 1 to 5. On the other hand, if the qubits can be moved, it is not necessarily required to arrange the qubits in a two-dimensional manner. An example of this is shown in FIG. 6B. In FIG. 6B, the data qubits numbered 1 to 9 in the two-dimensional arrangement of FIG. 6A are aligned in a single row, and the syndrome qubits numbered a to h are aligned in parallel with the data qubits.

In FIG. 6B, for example, data qubit 1 is a nearest neighbor to syndrome qubit c. Here, if the syndrome qubits are moved left and right, the nearest-neighbor combination changes. Therefore, if the syndrome qubits can be moved, all the nearest-neighbor positions required in FIG. 6A can be realized. A qubit array using semiconductor electron spins allows the movement (shuttling) of electrons (qubits), so that a surface code can be implemented using two parallel one-dimensional arrangements (2×N arrangement). In FIG. 6B, no qubits are arranged above the data qubits or below the syndrome qubits. Therefore, it is possible to secure a wide space for control lines and the like. In addition, although the syndrome qubits are moved in FIG. 6B, the data qubits may be moved instead.

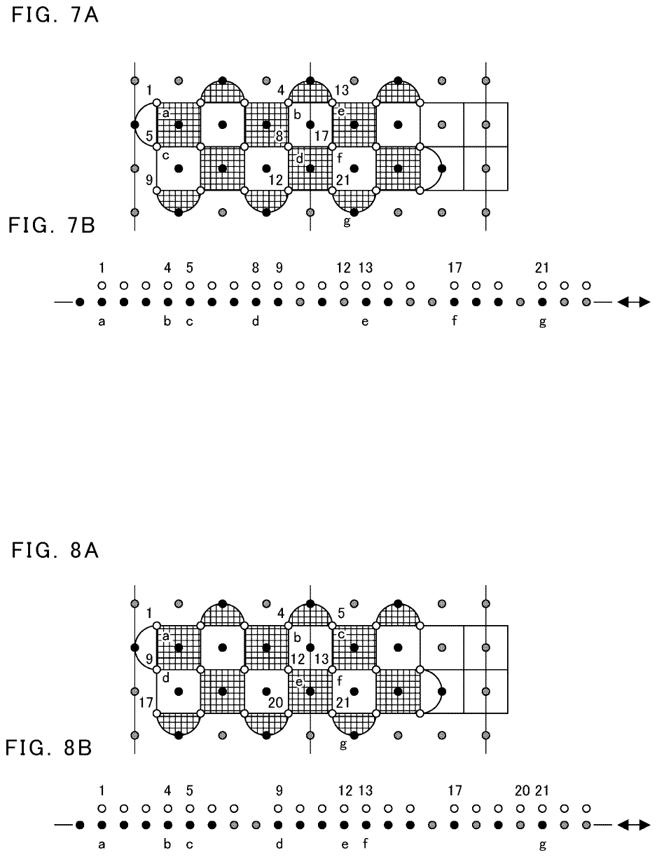

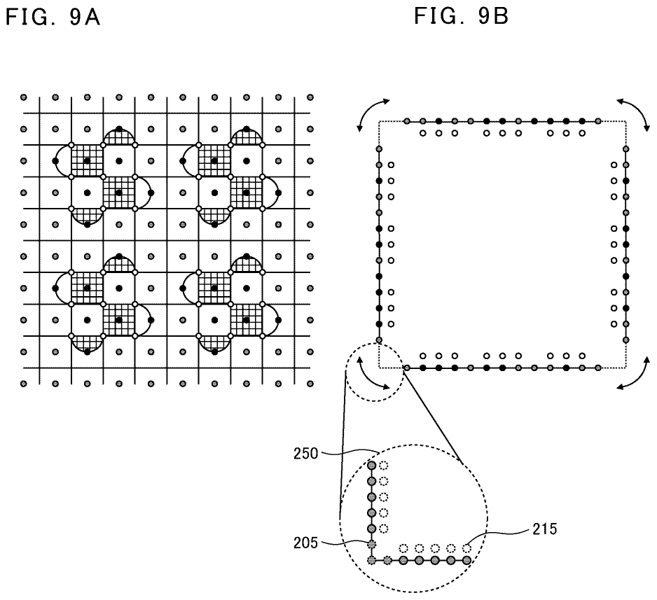

In FIG. 6B, gray circles (for example, 202) are aligned in the row of syndrome qubits (black circles). These are vacant positions for syndrome qubits. Their role will be explained with reference to FIGS. 7A to 8B.

When there are a plurality of logical qubits, if they are each independent, they can be simply put in a one-dimensional manner connected with each other. However, it is necessary to secure qubits for merging the adjacent logical qubits (see the upper left of FIG. 4). FIGS. 7A to 8B show cases where two logical qubits are merged. Since the positions that were vacant before merging become a part of the logical qubit, the number of data qubits and syndrome qubits used increases.

Some of the circles that were gray in FIG. 6B are black circles in FIGS. 7A to 8B. The same applies to data qubits; although FIGS. 6A and 6B only show data qubits in use, other data qubits are equipped for merging logical qubits in practice. For example, data qubits 4, 8, and 12 in FIGS. 7A and 7B and data qubits 4, 12, and 20 in FIGS. 8A and 8B are data qubits used in merging.

There are various options for how to arrange physical qubits when aligning a plurality of logical qubits in a one-dimensional manner. FIG. 7B shows a case where individual logical qubits are arranged as units. Here, the portions used in merging are also included. The dotted lines in FIG. 7A indicate the boundaries of the logical qubits before merging. FIG. 8B shows a case where two logical qubits merged are treated as a single unit and the physical qubits are aligned accordingly. Either arrangement is acceptable.

### Second Embodiment

In the first embodiment, the data qubits and the syndrome qubits are arranged in parallel in a one-dimensional manner to secure space for control lines and the like. Since the main purpose is to secure space for control lines and the like, it is not necessary for the arrangement to be exactly one-dimensional. The ends of the one-dimensional arrangement may be connected to form a closed arrangement. An example of a closed arrangement of physical qubits equivalent to four logical qubits is shown in FIG. 9B. By connecting the ends, the logical qubits on both ends can be arranged adjacent to each other.

In addition, since the arrangement is basically one-dimensional, sufficient space for control lines and the like is secured. The original two-dimensional arrangement is shown in FIG. 9A. The arrangement of FIG. 9B is geometrically a ring, and the qubits may be arranged in a circle instead of a square. However, because semiconductor technology typically arranges gate electrodes in vertical and horizontal lines, the arrangement of FIG. 9B is used.

In FIG. 9A, four logical qubits are arranged. Each logical qubit includes nine data qubits. FIG. 9B shows the corresponding 4×9=36 data qubits. The data qubits used in merging logical qubits are not shown. The data qubits used in merging are vacant in FIG. 9B.

Not all of 41 the syndrome qubits shown in FIG. 9A and syndrome qubits used in merging are shown in FIG. 9B. Only the syndrome qubits located at the nearest positions above the data qubits of FIG. 9A are shown in FIG. 9B. Therefore, in practice, more qubits or electrons usable as qubits are arranged in FIG. 9B than are displayed.

The syndrome qubits not shown in FIG. 9B are located at the four corners of the square. A specific example enlarged is shown within the dashed line in the lower left of FIG. 9B (250). In addition to the unused syndrome qubits shown as gray solid circles, there are also gray dotted circles (for example, 205). This is one method for corner handling, and it means that quantum dots are used for moving (shuttling) syndrome qubits. Within the enlarged dashed circle 250, unused data qubits are also shown as white dotted circles (for example, 215).

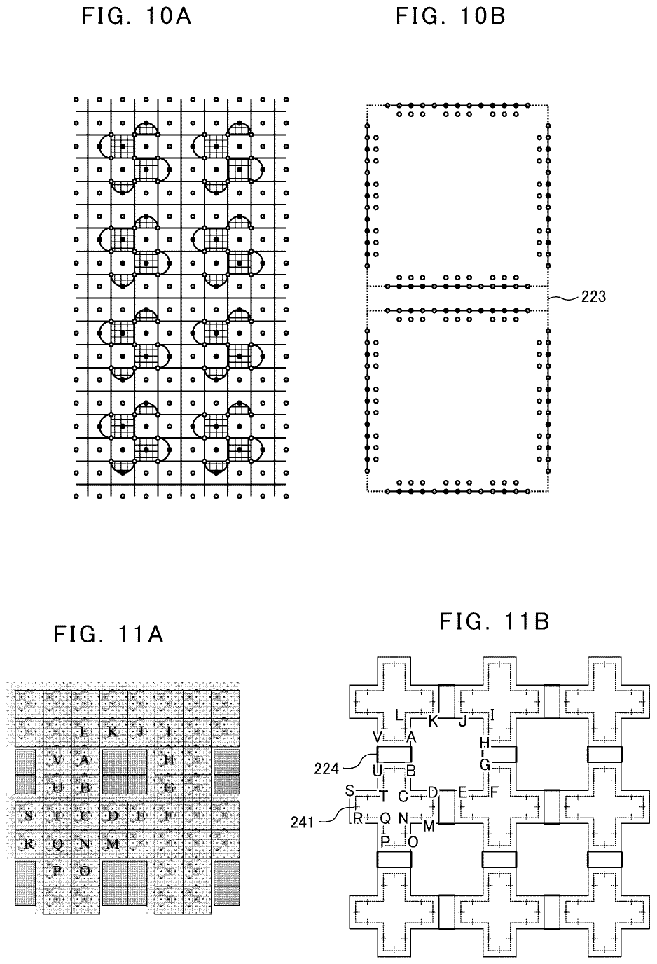

The number of logical qubits can be increased by aligning a plurality of squares (circular arrangement) shown in FIG. 9B. FIG. 10B shows a case where two squares are aligned. FIG. 10A shows the original two-dimensional arrangement, which corresponds to eight logical qubits. In FIG. 9B, unused syndrome qubits or quantum dots for shuttling are arranged in the dotted corner portion. The same applies to FIG. 10B.

In FIG. 10B, two squares are further connected by dotted lines (for example, 223). These connecting dotted lines form a passage for the syndrome qubit to travel between the upper and lower squares, and the dotted lines are formed by quantum dots. Through this passage, coupling between the logical qubits belonging to the upper side and the logical qubits belonging to the lower side becomes possible. That is, thanks to this passage, eight logical qubits can be merged either directly or indirectly. This structure is geometrically coupled two rings. Considering also that the data qubits and the syndrome qubits form a double ring, the structure can be expressed as coupled double-rings.

The coupled double-ring structure has the following advantages for example. First, thanks to the double-ring structure, a syndrome qubit is always located nearest to each data qubit. This means that the number of qubits forming each ring is kept to the minimum necessary, and the shuttling distance required for the syndrome qubits is minimized. Shuttling can reduce fidelity, and minimizing this is a good property. This is a property that cannot be expected from the single-ring structure disclosed in Zhenyu Cai et al., Phys. Rev. X4, 020345 (2023) or Adam Siegel et al., arXiv:2501.02120. Second, in the coupled double-ring structure, only the outer ring is coupled, and the inner ring is a simple ring. As a result, the structure is simplified, and implementation and operation become simpler and easier.

In FIG. 10B, two rings each including four logical qubits are coupled. The number of rings to be coupled is arbitrary, and the number of logical qubits forming each ring is also arbitrary. FIGS. 11A and 11B shows a case where one ring includes 12 logical qubits. For example, the dashed line connecting the blocks B, C, D, M, N, O, P, Q, R, S, T, and U in FIG. 11B is a single ring formed by arranging the data qubits belonging to the blocks B, C, D, M, N, O, P, Q, R, S, T, and U in FIG. 11A in a one-dimensional manner. The solid lines in FIG. 11B indicate the arrangement of syndrome qubits. The thin dotted lines (for example, 241) drawn perpendicular to the dashed lines indicate the boundaries between the blocks.

The thick solid lines (for example, 224) between A and B or between V and U in FIG. 11B are passages through which syndrome qubits can travel between the respective blocks. Qubits (quantum dots) are arranged only on the solid lines (including the thick solid lines) and the dashed lines, and all other portions are empty space that are used for control lines and the like. In FIG. 11A, the gray portions mean empty space. Although in the two-dimensional arrangement the empty space is limited, a large empty space is secured in FIG. 11B.

In the present invention, when realizing an interaction between logical qubits that are not adjacent to each other, the concept of 103 in FIG. 5 is used. The interaction between logical qubits is realized by merging and splitting two logical qubits. When two logical qubits are far apart from each other, logical qubits interposed therebetween may be merged and split. 103 in FIG. 5 indicates a merged state in this case. Let us apply this method to the cases shown in FIGS. 11A and 11B. To make block A and block F interact with each other, blocks A, B, C, D, E, and F may be merged. In this case, the merged logical qubit includes the region for connecting the respective blocks. That is, syndrome measurement (stabilizer measurement) will be performed in the connecting region.

In the embodiment, the positions of the data qubits are fixed and the syndrome qubits are shuttled. This is because the data qubits hold the information. In general, shuttling reduces fidelity. To minimize this effect, it is advantageous to fix the data qubits and shuttle the syndrome qubits. There are no particular disadvantages associated with fixing the data qubits. As described above, interactions between distant logical qubits are possible, the coupled double-ring structure works well, and simplicity and ease of implementation and operation are also guaranteed.

Note that this does not deny the possibility of fixing the syndrome qubits and shuttling the data qubits. Depending on the application, this option may also be available. For example, it becomes possible to move the logical qubits by moving the data qubits.

### Third Embodiment

The present invention is based on the configuration in which syndrome qubits and data qubits are arranged in parallel in a one-dimensional manner as shown in FIGS. 6A to 8B, and these are arranged in a square shape with both ends connected as shown in FIG. 9B. The four corners of the square are special points from the device-structure point of view. In addition, the number of bends is further increased in the structure in FIG. 11B. In the present embodiment, the handling of the bent portion will be described.

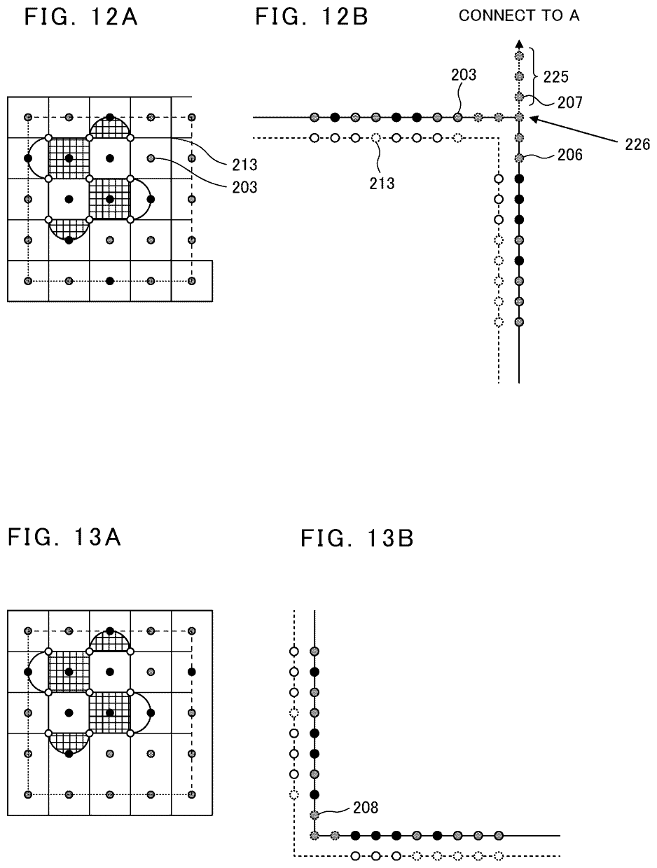

The qubits belonging to block B in FIGS. 11A and 11B are shown in FIGS. 12A and 12B. In FIG. 12A, the qubits within a range surrounded by the dashed and dotted lines belong to block B. Here, the syndrome qubits on the dashed lines belong precisely to block B, but the syndrome qubits on the dotted lines belong correctly to one of the blocks U, T, and C (see FIGS. 11A and 11B). However, since the syndrome qubits on the dotted lines are located at the boundaries between U, T, C and B, these perform a CNOT operation not only with the data qubits belonging to U, T, C but also with the data qubits belonging to B. FIG. 12B shows all the data qubits and syndrome qubits belonging to block B, and it also shows the connection path (225) to block A.

In FIG. 12B, the data qubits (white circles) are located on the dashed line. The dotted white circles (for example, 213) in the row of white circles are located on the lattice in FIG. 12A and can serve as data qubits when logical qubits are merged. The syndrome qubits (black circles) are located on the solid line in FIG. 12B, and the solid gray circles in that row can be used as syndrome qubits when logical qubits are merged (for example, 203), and are located on the surface in FIG. 12A.

The syndrome qubit sequence (on the solid line) also includes dotted gray circles (for example, 206). This is a quantum dot for supporting the 90° bend of a syndrome-qubit row, and it does not operate as a syndrome qubit at that position, but serves to provide a shuttling path. Dotted gray circles are also present in the upper right corner of FIG. 12B (on the dotted line, for example, 207). These are quantum dots that form the path for bridging block B and block A and are used for shuttling. These locations also are not served as syndrome qubits.

In the 90° bend in FIG. 12B showing block B, the data qubits are located on the inside of the bend. In block C shown in FIG. 13B, the syndrome qubit is on the inside. Regardless of which side is inside, the process of the 90° bend is the same; quantum dots represented by dotted gray circles (for example, 208) are arranged to form a shuttling path.

### Fourth Embodiment

So far, we have focused on the positional relationship between data qubits and syndrome qubits. The syndrome qubits are measured after performing CNOT operations with the data qubits. In the present embodiment, the measurement will be described.

In qubits using semiconductor electron spins, the upward spin |↑> and the downward spin |↓> correspond to |0> and |1>, respectively. It is difficult to directly distinguish between |↑> and |↓>, so the spin information is converted into charge information before measurement. The conversion is performed by newly providing a quantum dot for measurement that stores an upward electron spin, bringing the syndrome qubit close to the quantum dot for measurement, and further moving the syndrome qubit to the quantum dot for measurement.

If the syndrome qubit is |↑>, its spin direction matches that of the |↑> stored in the quantum dot for measurement, and accordingly, it cannot move according to the Pauli exclusion principle. However, if the syndrome qubit is |↓>, its spin direction is not oriented to that of the |↑> stored in the quantum dot for measurement, and accordingly, it can move owing to the Pauli exclusion principle not working.

As a result, the number of electrons in the quantum dot for measurement remains one in the former case, while it becomes two in the latter. The spin information is converted into the number electrons (spin-charge conversion). In the measurement, the difference between one and two is detected. Here, the phenomenon that movement cannot be made in the case of |↑> and |↑> is called Pauli spin blockade.

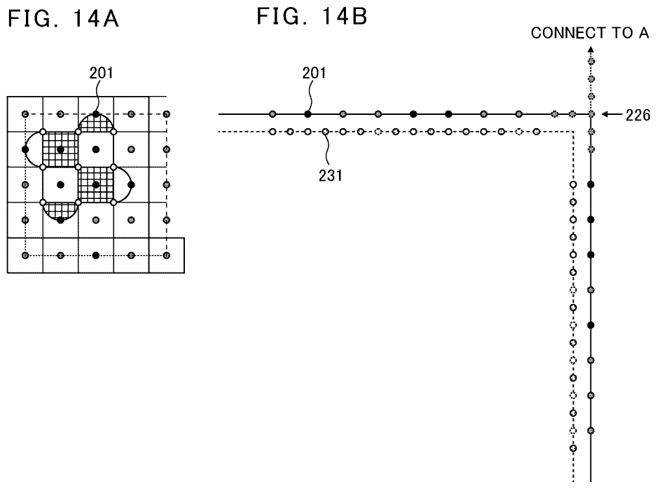

In order to apply this principle, it is necessary to arrange the quantum dots for measurement, and this is shown in FIG. 14B by adding it to FIG. 12B corresponding to block B. The solid dotted circles (for example, 231) arranged in the row of data qubits on the dashed line are quantum dots for measurement. A syndrome qubit exists for each data qubit at the facing position. On the other hand, the quantum dot for measurement is newly added, and no syndrome qubit exists at the facing positions on the solid line.

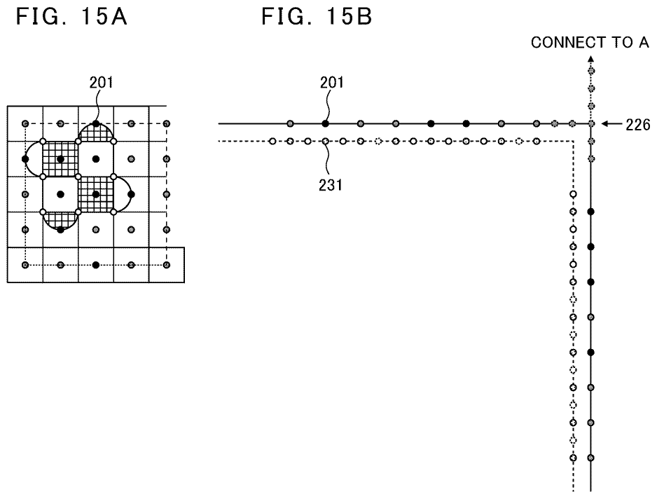

When measuring the syndrome qubits, these are moved to positions facing the quantum dots for measurement, as shown in FIG. 15B. For example, 201 in FIG. 14B is moved to 201 in FIG. 15B. In this position, spin-charge conversion is performed, and then the charge of the quantum dot for measurement is measured. After the measurement, the syndrome qubit is returned to its original position to re-enter the cycle of syndrome measurement (stabilizer) (process in FIG. 2).

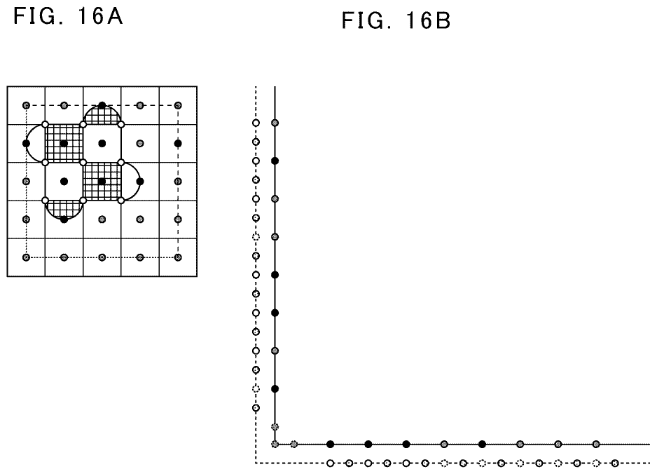

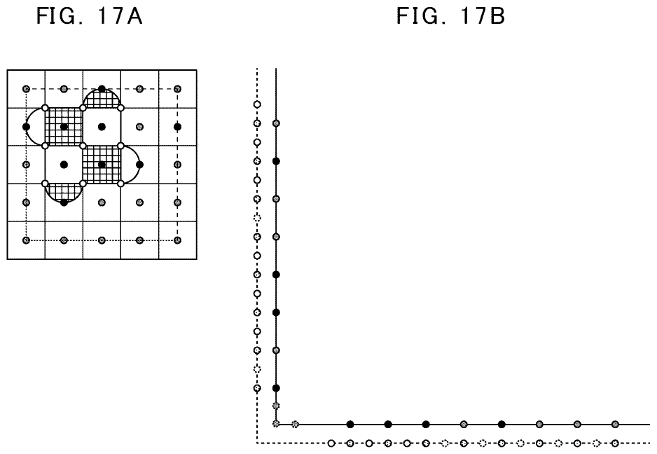

FIGS. 14B and 15B are diagrams in which quantum dots for measurement have been added to FIG. 12B. Similarly, FIGS. 16B and 17B are diagrams in which quantum dots for measurement are added to FIG. 13B. FIG. 16B is a diagram in which quantum dots for measurement are added between the data qubits, and FIG. 17B is a diagram in which the syndrome qubits have been moved to positions facing the quantum dots for measurement.

### Fifth Embodiment

In the first to fourth embodiments, it has been described that electrons are placed in quantum dots and used as qubits or measurement electrons and that the data qubits and measurement electrons are fixed and the syndrome qubits are moved (shuttled). The formation of quantum dots and the shuttling of electrons (qubits) are realized using gate electrodes formed on a semiconductor substrate.

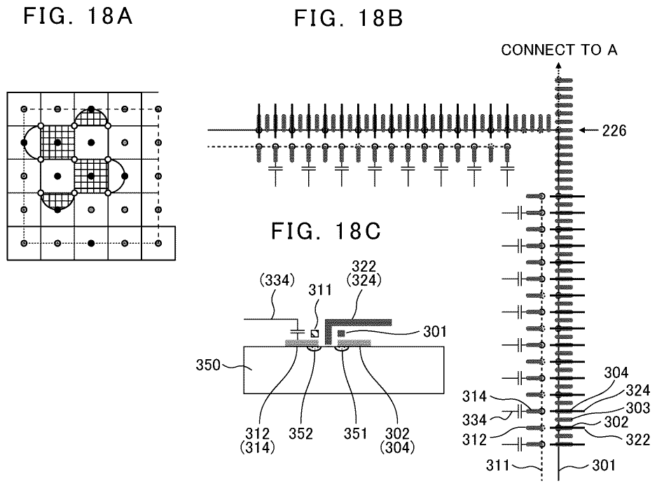

An example of mounting electrodes in the case of FIG. 14B corresponding to block B is shown in FIG. 18B. The quantum dots are formed on the substrate at the intersections of the common gate electrode and the individual gate electrodes. The solid line 301 in FIG. 18B is the common gate electrode for syndrome qubits, and the gray patches (for example, 302) are the individual gate electrodes. FIG. 18C shows a cross-sectional view of the electrode structure. A quantum dot 351 is formed on a semiconductor substrate 350 at the intersection of 301 and 302. The syndrome qubit needs to be moved (shuttled). For that purpose, AC voltages with phase shifts are applied to the individual gate electrodes, which modulates the depth of each quantum dot, and which causes the location with a deep potential move, for example, in the order of 302, 303, and 304. In this manner, the syndrome qubit is moved.

Here, attention is focused on a T-junction 226 that leads to the connection path to block A. The gate for shuttling can also be well arranged at a T-junction, but it cannot be formed at an intersection because the gray patches would overlap there. In the present embodiment of the present invention, there are no intersections. This is one of the consequences derived from the basic configuration of the present invention, and means that implementation and operation are simple and easy.

In the arrangement of data qubits, the dashed line 311 is the common gate electrode. An individual gate electrode for the data qubit is, for example, 312. A quantum dot 352 is formed at the intersection of 311 and 312 on the semiconductor substrate 350. Since the data qubits do not need to be moved, the gate electrode corresponding to 303 on the syndrome-qubit row is not on the data-qubit row.

A quantum dot for measurement (for example, 231 in FIGS. 14B and 15B) is placed on the data-qubit row. An individual gate electrode for forming the quantum dot for measurement is, for example, 314 in FIG. 18B.

A CNOT operation is performed between the data qubit and the syndrome qubit. The CNOT is realized through an interaction between the qubits. This interaction needs to be turned on and off. Therefore, for example, the height of the potential barrier between the quantum dots 351 and 352 is adjusted by using the gate electrode 322.

When the syndrome qubit is moved to the quantum dot for measurement, the potential barrier between those two dots needs to be lowered. This is done, for example, by using the gate electrode 324. After the movement, the number of electrons in the quantum dot below 314 becomes 1 or 2 depending on whether the syndrome qubit is |↑> or |↓>. This difference is reflected in the impedance of the gate electrode 314. For example, when RF is input through a wire 334, the difference in impedance appears as a change in reflection characteristics (reflectance). By using this change, it is possible to distinguish between electron numbers 1 and 2.

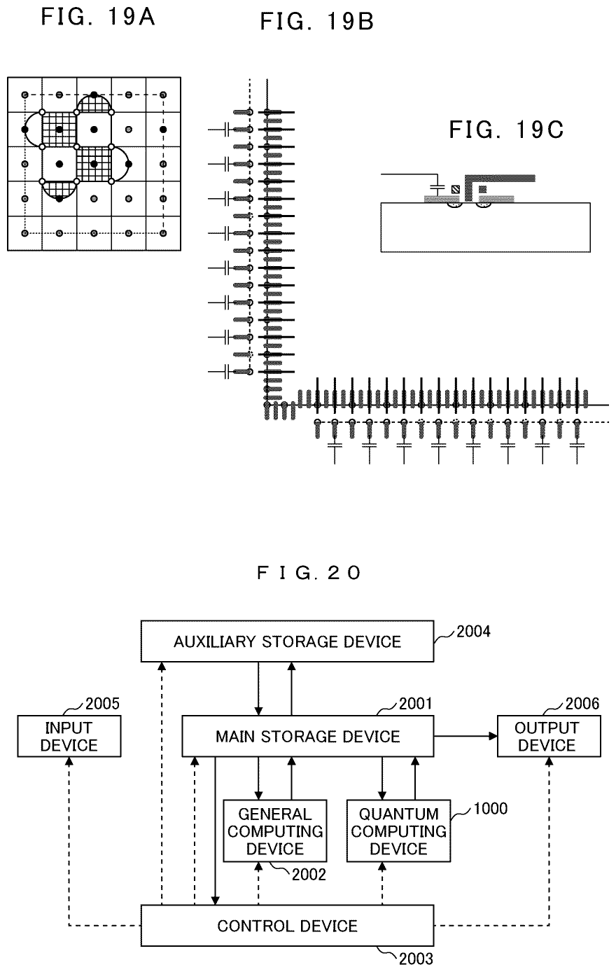

As described above, an example of forming electrodes has been shown using FIG. 18B corresponding to FIG. 14B. A similar example for block C, corresponding to FIG. 16B, is shown in FIGS. 19A and 19B.

### Sixth Embodiment

Up to the fifth embodiment, the arrangement, movement, and operation of the qubits have been described from the viewpoints of geometric arrangement and device structure, and in relation to the operational principles of the quantum error correcting code. In the present embodiment, how the quantum device is used in the entire system will be described.

FIG. 20 shows an example of the computer configuration of the present embodiment. FIG. 20 is similar to the configuration of an ordinary computer, but it is characterized in that a quantum computing device 1000 is included. The quantum computing device 1000 is a quantum computing device that includes the qubit array described in each of the first to fifth embodiments. Other general computations are performed by a general computing device 2002.

The above configuration may be implemented as an integrated computer, or any of the components, such as a main storage device 2001, the general computing device 2002, a control device 2003, an auxiliary storage device 2004, an input device 2005, and an output device 2006, may be configured as other computers connected through a network.

General computations are performed in the same procedure as in an ordinary computer. Data is exchanged between the main storage device 2001, which is a storage unit, and the general computing device 2002, which is a computation unit, and the computations proceed through the repetition of this process. During this process, the control device 2003 performs overall control. The programs executed by the general computing device 2002 are stored in a main storage device 2001, which is a storage unit. If the storage capacity of the main storage device 2001 is insufficient, the auxiliary storage device 2004, which is also a storage unit, is used. The input device 2005 is used to input data, programs, and the like, and the output device 2006 is used to output the results. The input device 2005 includes an interface for network connection as well as a manual input device such as a keyboard. This interface also serves as an output device.

Quantum computations are performed in a similar procedure. Data is exchanged between the main storage device 2001, which is the storage unit, and the quantum computing device 1000, which is a computation unit, and the computations proceed through the repetition of this process. During this process, the control device 2003 performs overall control. The programs executed by the quantum computing device 1000 are stored in the main storage device 2001, which is a storage unit.

The program is translated into a language used in the quantum computing device 1000 using the general computing device 2002 and stored in the main storage device 2001. If the storage capacity is insufficient, the auxiliary storage device 2004, which is also a storage unit, is used. The translated program is transmitted from the main storage device 2001 to the quantum computing device 1000, and the control device 2003 transmits a control signal to the quantum computing device 1000 according to the translated program to execute the computation. The execution results of the quantum computing device 1000 are transmitted to the main storage device 2001 and if necessary, post-processed by the general computing device 2002.

In the embodiments described above, either the data qubits or the syndrome qubits are arranged in a ring (loop shape), and the other is arranged in a ring shape outside the ring, forming a double-ring structure. The qubits belonging to the two rings are positioned so that nearest-neighbor qubits can interact with each other. The outer qubits are moved (shuttled) along the ring to perform the required information transfer while changing the combination of the nearest-neighbor qubits. The number of logical qubits belonging to each ring is set to about O(1) (order of 1), and a plurality of double rings are prepared and arranged two-dimensionally according to the number of logical qubits required. A bridging path is placed between adjacent double rings so that the outer qubits can move between the double rings. In this manner, both the securing of space for control lines and the like and highly flexible logical qubit computations are compatible.

The double-ring structure in the qubit array of the above embodiment is a closed curve of a 2×N array with small N and it is one-dimensional, making it possible to secure a large space required for control lines and the like. While this is one-dimensional in this sense, a plurality of double rings are arranged two-dimensionally, enabling parallel computations. Since qubits can travel between adjacent double rings, all logical qubits are directly or indirectly connected, enabling interaction between any pair of all logical qubits in effect. With this configuration, both the securing of space for control lines and the like and parallel computations are compatible.

According to the embodiments described above, space for control lines and the like is secured, and highly flexible logical qubit computations are enabled. In this manner, computations between a plurality of logical qubits that implement quantum error correction can be realized while securing the space for the wiring and elements required for qubit control.
101, 102: logical qubit
103: merged logical qubit
201: syndrome qubit
202, 203: unused syndrome qubit
205, 206, 207, 208: quantum dot for shuttling
213: unused data qubit
215: unused data qubit
223, 224, 225: bridging path
226: T-junction
231: quantum dot for measurement (electron in quantum dot for measurement)
241: boundary between blocks
250: circle representing enlarged view
301: common gate electrode for forming quantum dots for syndrome qubits
302, 303, 304: individual gate electrode for forming quantum dots for syndrome qubits
311: common gate electrode for forming data qubits and quantum dots for measurement
312: individual gate electrode for forming the quantum dot for a data qubit
314: individual gate electrode for forming a quantum dot for measurement
322: gate electrode for adjusting interaction between the data qubit and syndrome qubit
324: gate electrode for adjusting interaction between the quantum dot for measurement and the quantum dot for a syndrome qubit
334: wire used in syndrome measurement
350: semiconductor substrate
1000: quantum computing device
2001: main storage device
2002: general computing device
2003: control device
2004: auxiliary storage device
2005: input device
2006: output device

What is claimed is:

1. A qubit array, comprising:
a first quantum dot row in which a plurality of data qubits or a plurality of syndrome qubits are arranged so as to be movable; and
a second quantum dot row in which the plurality of data qubits or the plurality of syndrome qubits are fixed,
wherein a double ring including an outer ring and an inner ring is formed by arranging a pair of the first quantum dot row and the second quantum dot row in a loop shape,
by using a plurality of gate electrodes, the plurality of data qubits or the plurality of syndrome qubits are moved along the first quantum dot row to change positional relationships between the first quantum dot row and the second quantum dot row, i.e., the relationships between the plurality of data qubits and the plurality of syndrome qubits, and
by using the plurality of gate electrodes, two-qubit computations are executed between the plurality of data qubits and the plurality of syndrome qubits while changing the positional relationships.

2. The qubit array according to claim 1,
wherein, by moving the plurality of data qubits or the plurality of syndrome qubits along the first quantum dot row, a nearest-neighbor pair in which the data qubit and the syndrome qubit are located nearest to each other is changed in time series between the first quantum dot row and the second quantum dot row, and
at the nearest-neighbor position, the two-qubit computation is executed between the data qubit and the syndrome qubit forming the nearest-neighbor pair to perform data transfer required with a quantum error correcting code.

3. The qubit array according to claim 1,
wherein the first quantum dot row in which the plurality of data qubits or the plurality of syndrome qubits move is arranged in the outer ring of the double ring, and
the second quantum dot row in which the plurality of data qubits or the plurality of syndrome qubits are fixed is arranged in the inner ring of the double ring.

4. The qubit array according to claim 3,
wherein only the plurality of syndrome qubits are arranged in a movable manner in the first quantum dot row arranged in the outer ring, and
only the plurality of data qubits are fixedly arranged in the second quantum dot row arranged in the inner ring.

5. The qubit array according to claim 1,
wherein the double loop is formed by a combination of straight portions and bent portions.

6. The qubit array according to claim 5,
wherein quantum dots for shuttling, to which the data qubits or the syndrome qubits can be moved, are arranged near the bent portion.

7. The qubit array according to claim 6,
wherein a plurality of the double rings arranged in the loop shape are arranged,
the quantum dots for shuttling to which the data qubits or the syndrome qubits can be moved are arranged between the plurality of double rings, and
the plurality of double rings are coupled using the quantum dots for shuttling.

8. The qubit array according to claim 7,
wherein a path is provided, along which the data qubits or the syndrome qubits can be moved across a plurality of the double rings, and
the plurality of double rings are coupled through the path.

9. The qubit array according to claim 8,
wherein the path is formed using a T-junction.

10. The qubit array according to claim 7,
wherein the plurality of double rings are formed
and a plurality of empty spaces used for control lines are arranged.

11. The qubit array according to claim 1,
wherein the plurality of gate electrodes are arranged along the double ring.

12. The qubit array according to claim 9,
wherein the plurality of gate electrodes are arranged along the T-junction.

13. The qubit array according to claim 1,
wherein measurement quantum dots for measuring the syndrome qubits arranged in the first quantum dot row are arranged in the second quantum dot row.

14. The qubit array according to claim 13,
wherein, when measuring the syndrome qubits, a state of each of the syndrome qubits is measured by using a principle that the number of electrons in the measurement quantum dot changes according to the state of each of the syndrome qubits.

15. The qubit array according to claim 14,
wherein the plurality of gate electrodes include a common gate electrode and individual electrodes,
and the data qubits, the syndrome qubits, and the measurement quantum dots are controlled using the common gate electrode and the individual electrodes.

16. The qubit array according to claim 15,
wherein the syndrome qubits are moved by controlling the individual gate electrodes using AC voltages with phase shifts.

17. The qubit array according to claim 1,
wherein the double ring forms logical qubits implementing a quantum error correction code, and
computations between the plurality of logical qubits are performed using the plurality of gate electrodes.

18. A quantum computer, comprising:
a quantum dot array having a plurality of data qubits and a plurality of syndrome qubits; and
a control device that controls the quantum dot array,
wherein the quantum dot array includes:
a first quantum dot row in which the plurality of data qubits or the plurality of syndrome qubits are arranged so as to be movable; and
a second quantum dot row in which the plurality of data qubits or the plurality of syndrome qubits are fixed,
a double ring including an outer ring and an inner ring is formed by arranging a pair of the first quantum dot row and the second quantum dot row in a loop shape, and
the control device changes positional relationships between the first quantum dot row and the second quantum dot row, i.e., the relationships between the plurality of data qubits and the plurality of syndrome qubits, by moving the plurality of data qubits or the plurality of syndrome qubits along the first quantum dot row using a plurality of gate electrodes, and executes two-qubit computations between the plurality of data qubits and the plurality of syndrome qubits while changing the positional relationships using the plurality of gate electrodes.

19. A quantum error detection method, comprising:
a step of forming a double ring including an outer ring and an inner ring by arranging a pair of a first quantum dot row and a second quantum dot row in a loop shape;
a step of arranging a plurality of data qubits or a plurality of syndrome qubits so as to be movable along the first quantum dot row;
a step of arranging the plurality of data qubits or the plurality of syndrome qubits at fixed positions along the second quantum dot row;
a step of changing positional relationships between the first quantum dot row and the second quantum dot row, i.e., relationships between the plurality of data qubits and the plurality of syndrome qubits, by moving the plurality of data qubits or the plurality of syndrome qubits along the first quantum dot row using a plurality of gate electrodes; and
a step of executing two-qubit computations between the plurality of data qubits and the plurality of syndrome qubits while changing the positional relationships using the plurality of gate electrodes.
